(19) United States
(12) Patent Application Publication
(10) Pub. No.: US 2021/0191577 A1
(43) Pub. Date: Jun. 24, 2021

(54) INFORMATION PROCESSING APPARATUS AND NON-TRANSITORY COMPUTER READABLE MEDIUM

(71) Applicant: FUJI XEROX CO., LTD., Tokyo (JP)

(72) Inventor: Kengo TOKUCHI, Kanagawa (JP)

(73) Assignee: FUJI XEROX CO., LTD., Tokyo (JP)

(21) Appl. No.: 16/890,617

(22) Filed: Jun. 2, 2020

(30) Foreign Application Priority Data
Dec. 19, 2019 (JP) 2019-229723

(51) Int. Cl. G06F 3/0481

(52) U.S. Cl. CPC G06F 3/0481

(57) ABSTRACT

An information processing apparatus includes a processor configured to present, in perspective, movement of an image formed in air.

### CROSS-REFERENCE TO RELATED APPLICATIONS

This application is based on and claims priority under 35 USC 119 from Japanese Patent Application No. 2019-229723 filed Dec. 19, 2019.

### BACKGROUND

### (i) Technical Field

The present disclosure relates to an information processing apparatus and a non-transitory computer readable medium.

### (ii) Related Art

Reception of emails or the like is currently indicated in popup windows or the like displayed in the periphery of a computer screen. Popup windows disappear from the computer screen when a predetermined period of time has elapsed (e.g., refer to Japanese Unexamined Patent Application Publication No. 2007-044241).

### SUMMARY

Techniques for forming images in the air have been recently proposed as new user interfaces. With the spread of such user interfaces employing images formed in the air, it is expected that techniques for notifying users of sending and receiving of document data based on characteristics of images formed in the air will be desired.

Aspects of non-limiting embodiments of the present disclosure relate to achieve various kinds of expression compared to when uniform images are formed in the air and move.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a processor configured to present, in perspective, movement of an image formed in air.

### BRIEF DESCRIPTION OF THE DRAWINGS

An exemplary embodiment of the present disclosure will be described in detail based on the following figures, wherein:

FIG. 1 is a diagram illustrating an example of the configuration of an information processing system according to an exemplary embodiment;

FIG. 2 is a flowchart illustrating a function of achieving movement of a mid-air image that represents sending and receiving of a message or the like;

FIG. 3 is a flowchart illustrating a function of achieving cancellation of sending or receiving of a message in accordance with an operation performed on the mid-air image while the mid-air image is moving;

FIGS. 4A to 4C are diagrams illustrating movement of the mid-air image at a time when a user around another mid-air image receives a message or the like: FIG. 4A illustrates a mid-air image formed at a time, FIG. 4B illustrates a mid-air image formed at another time, and FIG. 4C illustrates a mid-air image formed at another time;

FIGS. 5A to 5C are diagrams illustrating an example in which plural mid-air images having different sizes are used to express the mid-air image approaching the user: FIG. 5A illustrates a mid-air image formed at a time, FIG. 5B illustrates a mid-air image at another time, and FIG. 5C illustrates a mid-air image formed at another time;

FIG. 6 is a diagram illustrating an example in which the movement of the mid-air image reflects a positional relationship between a sender and a recipient in actual space;

FIG. 7 is a diagram illustrating another example in which the movement of the mid-air image reflects the positional relationship between the sender and the recipient in actual space;

FIG. 8 is a diagram illustrating another example in which the movement of the mid-air image reflects the positional relationship between the sender and the recipient in actual space;

FIGS. 9A and 9B are diagrams illustrating a case where a motion that prevents the movement of the mid-air image is detected: FIG. 9A illustrates a motion of a hand that prevents the movement of the mid-air image, and FIG. 9B illustrates a state after the motion of the hand that prevents the movement of the mid-air image is detected;

FIG. 10 is a diagram illustrating an example in which two mid-air images whose recipients are different from each other are formed;

FIGS. 11A to 11C are diagrams illustrating the movement of the mid-air image at a time when the user around the other mid-air image sends a message or the like: FIG. 11A illustrates a mid-air image formed at a time, FIG. 11B illustrates a mid-air image formed at another time, and FIG. 11C illustrates a mid-air image formed at another time;

FIGS. 12A to 12C are diagrams illustrating an example in which plural mid-air images having different sizes are used to express the mid-air image moving away from the user:

FIG. 12A illustrates a mid-air image formed at a time, FIG. 12B illustrates a mid-air image at another time, and FIG. 12C illustrates a mid-air image formed at another time;

FIG. 13 is a diagram illustrating another example in which the movement of the mid-air image reflects the positional relationship between the sender and the recipient in actual space;

FIG. 14 is a diagram illustrating another example in which the movement of the mid-air image reflects the positional relationship between the sender and the recipient in actual space;

FIG. 15 is a diagram illustrating another example in which the movement of the mid-air image reflects the positional relationship between the sender and the recipient in actual space;

FIGS. 16A and 16B are diagrams illustrating another case where a motion that prevents the movement of the mid-air image is detected: FIG. 16A illustrates a motion of a hand that prevents the mid-air image, and FIG. 16B illustrates a state after the motion of the hand that prevents the movement of the mid-air image is detected;

FIG. 17 is a diagram illustrating an example in which two mid-air images whose senders are different from each other are formed;

FIGS. 18A and 18B are diagrams illustrating an example in which the other mid-air image is not formed as a reference for the mid-air image: FIG. 18A illustrates movement of a mid-air image representing reception of a message or the like, and FIG. 18B illustrates movement of a mid-air image representing sending of a message or the like; and

FIGS. 19A and 19B are diagrams illustrating an example in which a shape of the mid-air image indicates the amount of data of a message or the like: FIG. 19A illustrates a shape corresponding to a small amount of data, and FIG. 19B illustrates a shape corresponding to a large amount of data.

### DETAILED DESCRIPTION

An exemplary embodiment of the present disclosure will be described hereinafter with reference to the drawings.

### Exemplary Embodiment

### System Configuration

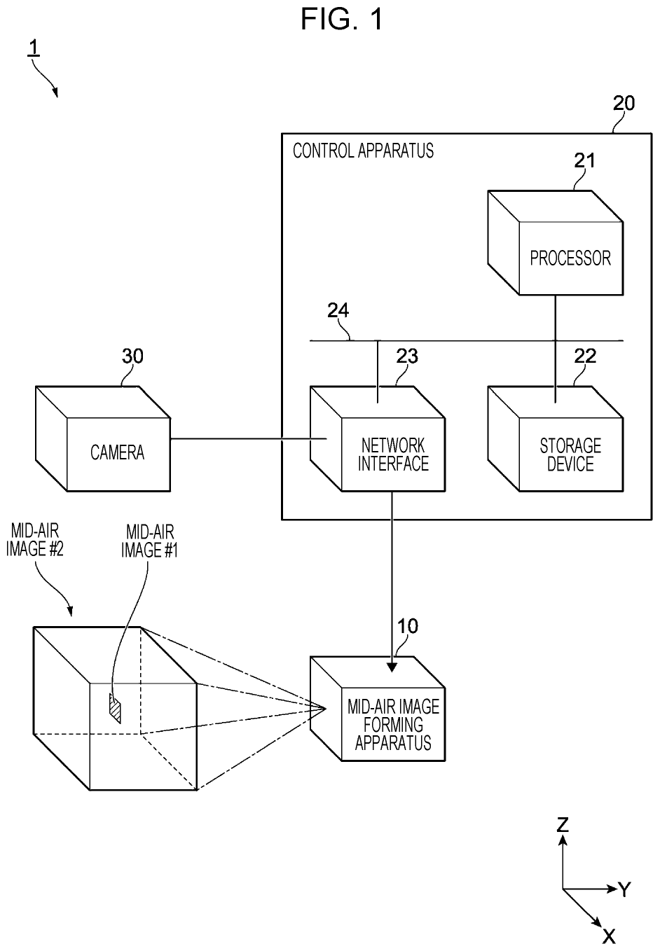

FIG. 1 is a diagram illustrating an example of the configuration of an information processing system 1 used in the exemplary embodiment.

The information processing system 1 illustrated in FIG. 1 includes a mid-air image forming apparatus 10 that forms images (hereinafter referred to as “mid-air images”) floating in the air, a control apparatus 20 that controls the mid-air image forming apparatus 10, and a camera 30 that captures the mid-air images and a space around the mid-air image.

In FIG. 1, two mid-air images #1 and #2 are formed in the air.

In the present exemplary embodiment, the mid-air image #1 is used to indicate presence of data to be communicated (hereinafter referred to as “communication data”). In other words, the mid-air image #1 is used to visually represent sending and receiving of communication data to a user of a service. The communication data may be, for example, a message, a data file, or control data.

The message may be a message whose address is a mail address or a message whose address is a telephone number. The data file may be content data or program data. The content data may be, for example, moving image data, still image data, audio data, web data, control data, or document data.

In the present exemplary embodiment, a position at which the mid-air image #1 is formed moves through the air. A direction in which the mid-air image #1 moves represents a direction of communication. Even when a communication partner is the same, therefore, the direction in which the mid-air image #1 moves is different between sending and receiving. The mid-air image #1 is an example of an image that moves through the air.

In the present exemplary embodiment, outer surfaces of the mid-air image #2 define a range within which the mid-air image #1 moves. In FIG. 1, the mid-air image #2 is a cube. The mid-air image #2, however, need not be a cube. For example, the mid-air image #2 may be a rectangular parallelepiped or a sphere, instead.

In the present exemplary embodiment, the mid-air image #2 is formed still in the air at a certain position. Since the mid-air image #2 is formed still in the air, movement of the mid-air image #1, which moves within the mid-air image #2, can be easily recognized. Because the mid-air image #2 is formed in the air as a reference for the mid-air image #1, however, the range within in which the mid-air image #1 moves need not be defined. That is, the mid-air image #1 may move out of the mid-air image #2 and move into the mid-air image #2. The mid-air image #2 is an example of another image.

The mid-air image #2 is not limited to an image that defines outer surfaces of a cube but may be expressed by outer surfaces of a cube and pixels inside the cube, instead. In other words, the mid-air image #2 may be expressed by voxel data. In this case, the mid-air image #1 may be part of the pixels of the mid-air image #2.

Although both the mid-air images #1 and #2 are formed in the air in FIG. 1, the mid-air image #1 is formed only when communication is detected. When no communication is detected, therefore, only the mid-air image #2 may be formed in the air.

The mid-air image #2 may be, as with the mid-air image #1, formed only when communication is detected. The control apparatus 20 controls the formation of the mid-air images #1 and #2.

The mid-air image forming apparatus 10 according to the present exemplary embodiment directly forms the mid-air images #1 and #2 in the air. Various methods have already been proposed for such apparatuses, and some of the methods have been put into practice.

The methods include, for example, a method in which a semi-transparent mirror is used to form the mid-air images #1 and #2, a method employing a beam splitter, a method employing a minute mirror array, a method employing a minute lens array, and a method employing plasma emission. Users can walk through the mid-air image #1 and #2 formed using one of these methods.

An example of the mid-air image forming apparatus 10 that forms the mid-air images #1 and #2 through which users cannot walk is a projector that projects the mid-air images #1 and #2 onto a screen present in actual space. Other examples of the mid-air image forming apparatus 10 include an apparatus that moves a light-emitting device array in actual space at high speed to form the mid-air images #1 and #2 as afterimages.

The control apparatus 20 includes a processor 21 that controls, by executing a program, the formation of the mid-air images #1 and #2 performed by the mid-air image forming apparatus 10, a storage device 22 storing programs and various types of data, a network interface 23 that achieves communication with the outside, and a signal line 24 that connects these components to each other, such as a bus. The control apparatus 20 is an example of an information processing apparatus.

The processor 21 is achieved, for example, by a central processing unit (CPU). The storage device 22 is achieved, for example, by a read-only memory (ROM) storing a basic input/output system (BIOS) and the like, a random-access memory (RAM) used as a working area, and a hard disk device storing a basic program, application programs, and the like.

Alternatively, the ROM and the RAM may be included in the processor 21. The processor 21 and the storage device 22 constitute a computer.

The camera 30 captures the mid-air images #1 and #2 and the space around the mid-air images #1 and #2. If there is a person around the mid-air images #1 and #2, therefore, an image captured by the camera 30 includes the person.

Although FIG. 1 illustrates only one camera 30, plural cameras 30 that capture images from different directions may be provided, instead.

An image captured by the camera 30 is output to the control apparatus 20 as image data. In the present exemplary embodiment, the processor 21 analyzes the image data and identifies a positional relationship between the space in which the mid-air images #1 and #2 are formed and a person around the mid-air images #1 and #2. If the image data includes a person's face, the processor 21 analyzes the person's face included in the image data and identifies the person around the mid-air images #1 and #2.

A person around the mid-air images #1 and #2 need not be identified using image data. For example, when the control apparatus 20 is an information terminal such as a computer or a smartphone used by a person, the person may be identified from account information regarding a login user, instead. Alternatively, information regarding a person around the space in which the mid-air images #1 and #2 are formed and a positional relationship between the person and the mid-air image #2 may be registered using a registration screen, which is not illustrated.

### Process for Forming Mid-Air Image #1

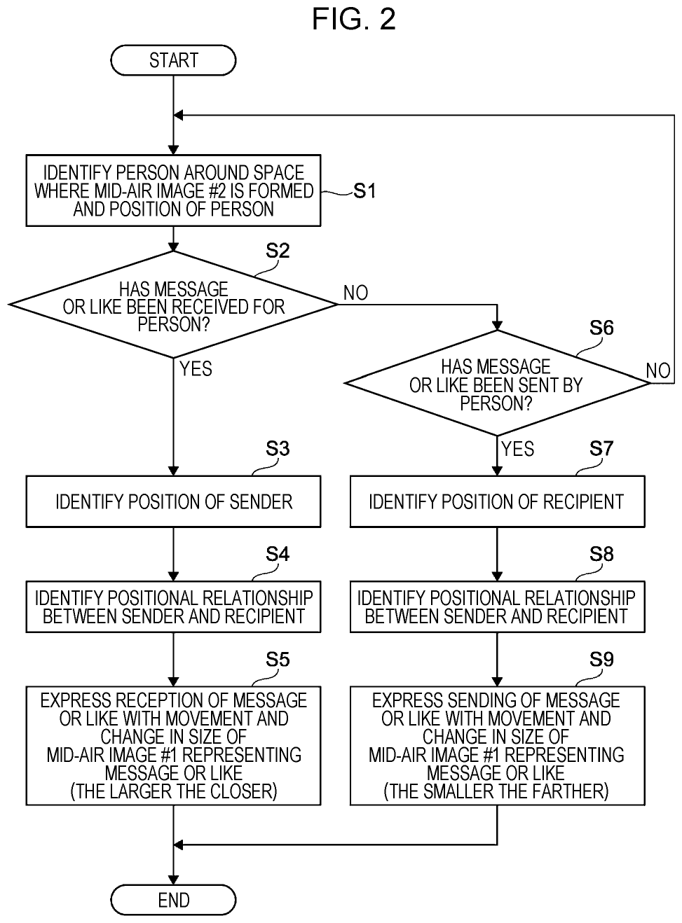

FIG. 2 is a flowchart illustrating a function of achieving movement of the mid-air image #1 that represents sending and receiving of a message or the like. A process illustrated in FIG. 2 is achieved by executing a program using the processor 21 (refer to FIG. 1).

First, the processor 21 identifies a person around the space in which the mid-air image #2 is formed and a position of the person (S1). A coordinate system defined for the camera 30, for example, is used to identify positions in space. In the present exemplary embodiment, a position in the space in which the mid-air image #2 is formed is associated with the coordinate system of the camera 30. The coordinate system is managed by the processor 21. In the present exemplary embodiment, the processor 21 extracts presence of the person from the image of the space in which the mid-air image #2 is formed. If possible, the processor 21 performs face recognition and identifies the extracted person.

Next, the processor 21 determines whether a message or the like has been received for the person (S2). The processor 21 according to the present exemplary embodiment cooperates with a mail server and determines whether a mail whose recipient is the person around the mid-air image #2 has been received. It is assumed in the present exemplary embodiment that any person around the mid-air image #2 has permitted the cooperation with the mail server. If the person has not permitted the cooperation with the mail server, steps after S2 are not performed. When the person cannot be identified, too, it is regarded that the cooperation with the mail server is not permitted.

If a result of S2 is positive, the processor 21 identifies a position of a sender of the mail (S3). The processor 21 identifies an area or an address, in actual space, of a terminal used by the sender of the mail on the basis of an Internet protocol (IP) address of a router or the like that has been passed through by the mail.

Next, the processor 21 identifies a positional relationship between the sender and the recipient (S4). A position of the recipient includes a position of an area in which the mid-air image #2 is formed and a position of the recipient relative to the mid-air image #2. The position of the recipient is identified, for example, from a side of the mid-air image #2 at which the person is located.

After identifying the positional relationship between the sender and the recipient, the processor 21 expresses the reception of the message or the like with movement and a change in the size of the mid-air image #1 representing the message or the like (S5). The movement represents the positional relationship between the sender and the recipient.

When the recipient is located at a near side of the mid-air image #2 and the sender is located at a far side of the mid-air image #2, for example, the mid-air image #1 corresponding to an icon representing the mail linearly moves from the far side of the mid-air image #2 to the near side of the mid-air image #2.

When the recipient is located at the near side of the mid-air image #2 and the sender is located at a right side of the recipient, for example, the mid-air image #1 corresponding to the icon representing the mail moves from a right side of the mid-air image #2 to the near side of the mid-air image #2 drawing a curve. Alternatively, the mid-air image #1 may move linearly instead of drawing a curve.

When the recipient is located at the near side of the mid-air image #2 and the sender is located at a left side of the recipient, for example, the mid-air image #1 corresponding to the icon representing the mail moves from a left side of the mid-air image #2 to the near side of the mid-air image #2 drawing a curve. Alternatively, the mid-air image #1 may move linearly instead of drawing a curve.

When the recipient is located at the near side of the mid-air image #2 and the sender is located behind the recipient, for example, the mid-air image #1 corresponding to the icon representing the mail moves from the near side of the mid-air image #2 to the far side of the mid-air image #2 and then makes a U-turn and moves to the near side of the mid-air image #2.

The mid-air image #1 need not necessarily make a U-turn. For example, the mid-air image #1 may linearly move from the far side of the mid-air image #2 to the near side of the mid-air image #2 while being displayed differently than when the sender is located in front of the recipient, instead. In this case, the mid-air image #1 moves in the same manner as when the sender is located in front of the recipient, but since the mid-air image #1 is displayed differently, it is possible to understand that the mid-air image #1 represents a mail from the sender located behind the recipient. When the color of the mid-air image #1 at a time when the sender is located in front of the recipient is blue, for example, the color of the mid-air image #1 at a time when the sender is located behind the recipient may be orange, which is a complement to blue. Whether the sender is located in front of or behind the recipient, however, need not necessarily be indicated by a complement. Socially accepted opposite colors, such as blue and red, may be used, or a difference in brightness may be used, instead.

In the present exemplary embodiment, movement of the mid-air image #1 represents the positional relationship between the sender and recipient in perspective. The mid-air image #1 in the present exemplary embodiment, however, need not be expressed in perspective in a strict sense, and it is sufficient that a distance between the sender and the recipient can be roughly identified. This is because the mid-air image #1 in the present exemplary embodiment moves in order to notify a person of reception of mail.

The distance may be represented on the basis of a physical distance between a position in the air at which the mid-air image #1 is formed and the recipient, or the length of a route from the position at which the mid-air image #1 appears first to a position near the recipient to which the mid-air image #1 moves. In the present exemplary embodiment, the size of the mid-air image #1 changes in accordance with the distance between the mid-air image #1 and the recipient. That is, the mid-air image #1 is smallest at the position at which the mid-air image mid-air image #1 appears first, and becomes larger as the mid-air image #1 approaches the recipient.

When the sender of a mail is located behind the recipient and the mid-air image #1 makes a U-turn, therefore, the mid-air image #1 is smallest at a position at which the mid-air image #1 appears first.

Not the entirety of mid-air images need not be presented in perspective, that is, only part of mid-air images may be presented in perspective. A user may switch a display method between perspective and normal display. “Normal display” refers to a method in which mid-air images that are not presented in perspective move through the air without changing sizes. If the user switches the display method, mid-air images are displayed in an appropriate manner by a new display method even if the mid-air images presented in perspective or normal display are moving.

Only one mid-air image #1 is formed, for example, at each point in time. An image of a line indicating a trajectory of movement of the mid-air image #1 may also be formed so that the user can recognize how the mid-air image mid-air image #1 has moved.

Alternatively, the movement of the mid-air image #1 may be presented by leaving a mid-air image #1 having a position and a size corresponding to each time point. In this case, plural mid-air images #1 having different sizes are displayed in the air, which makes it easier for the user to see the mid-air image #1 approaching.

If the result of S2 is negative, on the other hand, the processor 21 determines whether a message or the like has been received from the person (S6). The processor 21 determines, through the cooperation with the mail server, whether a mail whose sender is the person around the mid-air image #2 has been sent.

If a result of S6 is negative, the processor 21 returns to S1. As in the case of reception of a mail or the like, if the person has not permitted the cooperation with the mail server, the result of S6 becomes negative, and the process returns to S1.

If the result of S6 is positive, on the other hand, the processor 21 identifies a position of the sender of the mail (S7). The processor 21 obtains, from a network, information regarding an IP address of a router or the like that has been passed through by the mail and identifies an area or an address, in actual space, of a terminal used by the recipient of the mail.

Next, the processor 21 identifies the positional relationship between the sender and the recipient (S8). The position of the sender includes the position of the area in which the mid-air image #2 is formed and a position of the sender relative to the mid-air image #2. The position of the sender is identified in the same manner as the position of the recipient.

After identifying the positional relationship between the sender and the recipient, the processor 21 expresses the sending of the message or the like with movement and a change in the size of the mid-air image #1 representing the message or the like (S9). The movement represents the positional relationship between the sender and the recipient.

When the sender is located at the near side of the mid-air image #2 and the recipient is located at the far side of the mid-air image #2, for example, the mid-air image #1 corresponding to an icon representing the mail linearly moves from the near side of the mid-air image #2 to the far side of the mid-air image #2.

When the sender is located at the near side of the mid-air image #2 and the recipient is located at a right side of the sender, for example, the mid-air image #1 corresponding to the icon representing the mail moves from the near side of the mid-air image #2 to the right side of the mid-air image #2 drawing a curve. Alternatively, the mid-air image #1 may move linearly instead of drawing a curve.

When the sender is located at the near side of the mid-air image #2 and the recipient is located at a left side of the sender, for example, the mid-air image #1 corresponding to the icon representing the mail moves from the near side of the mid-air image #2 to the left side of the mid-air image #2 drawing a curve. Alternatively, the mid-air image #1 may move linearly instead of drawing a curve.

When the sender is located at the near side of the mid-air image #2 and the recipient is located behind the sender, for example, the mid-air image #1 corresponding to the icon representing the mail moves from the near side of the mid-air image #2 to the far side of the mid-air image #2 and then makes a U-turn and moves to the near side of the mid-air image #2.

The mid-air image #1 need not necessarily make a U-turn. For example, the mid-air image #1 may linearly move from the near side of the mid-air image #2 to the far side of the mid-air image #2 while being displayed differently than when the recipient is located in front of the sender, instead. In this case, the mid-air image #1 moves in the same manner as when the recipient is located in front of the sender, but since the mid-air image #1 is displayed differently, it is possible to understand that the mid-air image #1 represents a mail from the sender located in front of the recipient. When the color of the mid-air image #1 at a time when the recipient is located in front of the sender is blue, for example, the color of the mid-air image #1 at a time when the recipient is located behind the sender may be orange, which is a complement to blue. Whether the recipient is located in front of or behind the sender, however, need not necessarily be indicated by a complement. Socially accepted opposite colors, such as blue and red, may be used, or a difference in brightness may be used, instead.

In the present exemplary embodiment, movement of the mid-air image #1 representing sending of a message or the like, too, represents the positional relationship between the sender and recipient in perspective. The mid-air image #1 in the present exemplary embodiment, however, need not be presented in perspective in a strict sense, and it is sufficient that the distance between the sender and the recipient can be roughly identified. This is because the mid-air image #1 in the present exemplary embodiment moves in order to notify a person of sending of mail.

The distance may be represented on the basis of a physical distance between a position in the air at which the mid-air image #1 is formed and the recipient, or the length of a route from the position at which the mid-air image #1 appears first to a position near the recipient to which the mid-air image #1 moves. In the present exemplary embodiment, the size of the mid-air image #1 changes in accordance with the distance between the mid-air image #1 and the recipient. That is, the mid-air image #1 is largest at the position at which the mid-air image #1 appears first, and becomes smaller as the mid-air image #1 approaches the recipient.

When the recipient of a mail is located behind the sender and the mid-air image #1 makes a U-turn, therefore, the mid-air image #1 is largest at a position at which the mid-air image #1 appears first.

In the case of sending of a message or the like, too, only one mid-air image #1 is formed, for example, at each point in time. An image of a line indicating a trajectory of movement of the mid-air image #1 may also be formed so that the user can recognize how the mid-air image mid-air image #1 has moved.

Alternatively, the movement of the mid-air image #1 may be expressed by leaving a mid-air image #1 having a position and a size corresponding to each time point. In this case, plural mid-air images #1 having different sizes are displayed in the air, which makes it easier for the user to see the mid-air image #1 moving away.

Although the position of the sender is identified at a time of reception of a message or the like and the movement of the mid-air image #1 is controlled in accordance with the positional relationship between the sender and the recipient in the example illustrated in FIG. 2, the position of the sender need not be used for the control of the movement of the mid-air image #1. In this case, the mid-air image #1 linearly moves from the far side of the mid-air image #2 to the recipient while increasing the size. It is difficult for the recipient to understand his/her positional relationship with the sender from the movement of the mid-air image #1, but the recipient can visually understand that he/she has received a mail.

Similarly, at a time of sending of a message or the like, too, the position of the recipient need not be identified and used for the control of the movement of the mid-air image #1. In this case, the mid-air image #1 linearly moves from the recipient to the far side of the mid-air image #2 while reducing the size. It is difficult for the sender to understand his/her positional relationship with the recipient from the movement of the mid-air image #1, but the sender can visually understand that he/she has sent a mail.

Operation Performed on Mid-Air Image #1 during Movement

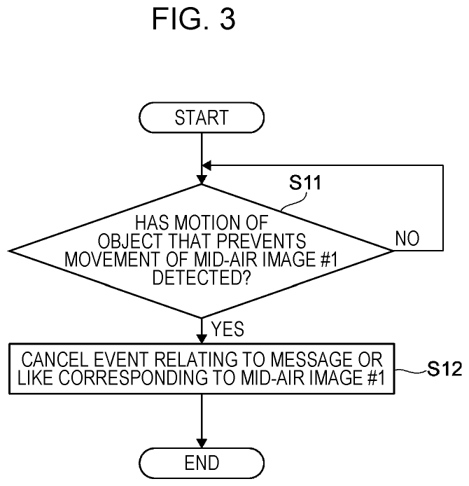

FIG. 3 is a flowchart illustrating a function of achieving cancellation of sending or receiving of a message in accordance with an operation performed on the mid-air image #1 while the mid-air image #1 is moving. A process illustrated in FIG. 3, too, is achieved by executing a program using the processor 21 (refer to FIG. 1). The process illustrated in FIG. 3 is performed independently of the process illustrated in FIG. 2. The processor 21, therefore, keeps analyzing an image captured by the camera 30 even while controlling the position and size of the mid-air image #1.

First, the processor 21 determines whether a motion of an object that prevents movement of the mid-air image #1 (S11). A motion of an object that prevents the movement is detected by analyzing an image captured by the camera 30 (refer to FIG. 1). Appearance of an object that obstructs the movement of the mid-air image #1, for example, is detected as a motion of an object that prevents the movement of the mid-air image #1. An act of grasping the mid-air image #1 by hand and an act of knocking down the mid-air image #1 by hand are also detected as motions of objects that prevent the movement of the mid-air image #1.

Any object may apply here, but assume a hand as an example. Whether a motion of an object prevents the movement of the mid-air image #1 is determined regardless of a type of object in the present exemplary embodiment, but motions of only predetermined types of object may be detected, instead. For example, a detection target may be limited to hands, and even if another type of object obstructs the movement of the mid-air image #1, the obstruction need not be detected as a motion of an object that prevents the movement of the mid-air image #1. In this case, the detection target is set in advance on an interface screen.

When plural mid-air images #1 have been formed in the air for a single user, a motion of an object that prevents movement is detected for each of the plural mid-air images #1. Alternatively, detection of a motion that prevents movement may be disabled for receiving, and detection of a motion that prevents movement may be enabled for sending.

Conversely, detection of a motion that prevents movement may be enabled for receiving, and detection of a motion that prevents movement may be disabled for sending. The user makes these settings, too, on the interface screen.

Any person may apply as an object whose motion prevents the movement of the mid-air image #1 in the present exemplary embodiment, but an object whose motion prevents the movement of the mid-air image #1 may be limited to a recipient or a sender of a message or the like. In this case, motions that prevent the movement of the mid-air image #1 made by persons other than the recipient or the sender are ignored.

A motion of an object that prevents the movement of the mid-air image #1 may be regarded as effective only if a message or the like corresponding to the mid-air image #1 and a person who has made the motion match. In this case, an event is not erroneously canceled, for example, when plural mid-air images #1 whose senders or receives are different from one another have been simultaneously formed. For example, when a mid-air image #1 corresponding to a user A and a mid-air image #1 corresponding to a user B are moving in the same space and the user A's hand cuts across the mid-air image #1 corresponding to the user B by mistake, an event may be canceled only for the mid-air image #1 corresponding to the user A.

If a motion of an object that prevents movement of one of plural mid-air images #1 corresponding to a single person is detected, all events corresponding to the person may be canceled. Because movement of mid-air images #1 corresponding to messages or the like ends in a short period of time, it might be difficult to prevent the movement of all the mid-air images #1. When the above-described function is employed, it becomes easier for the user to cancel events.

While a result of S11 remains negative, the processor 21 keeps making the determination in S11.

If the result of S11 becomes positive, on the other hand, the processor 21 cancels an event relating to a message or the like corresponding to the mid-air image #1 (S12). The event may be a process for achieving movement of the mid-air image #1 through the air in accordance with reception of a message or the like or a process for achieving movement of the mid-air image #1 through the air in accordance with sending of a message or the like. That is, the processor 21 cancels S2 to S5 or S6 to S9. As a result of the cancellation of the process, not only the movement of the mid-air image #1 inside the mid-air image #2 but also the formation of the mid-air image #1 is canceled. In the present exemplary embodiment, the mid-air image #1 corresponding to a message or the like is removed from the mid-air image #2.

### Examples of Formation of Mid-Air Image #1

Examples of formation of mid-air images #1 and #2 employing the above-described functions will be described hereinafter.

### FIRST EXAMPLE

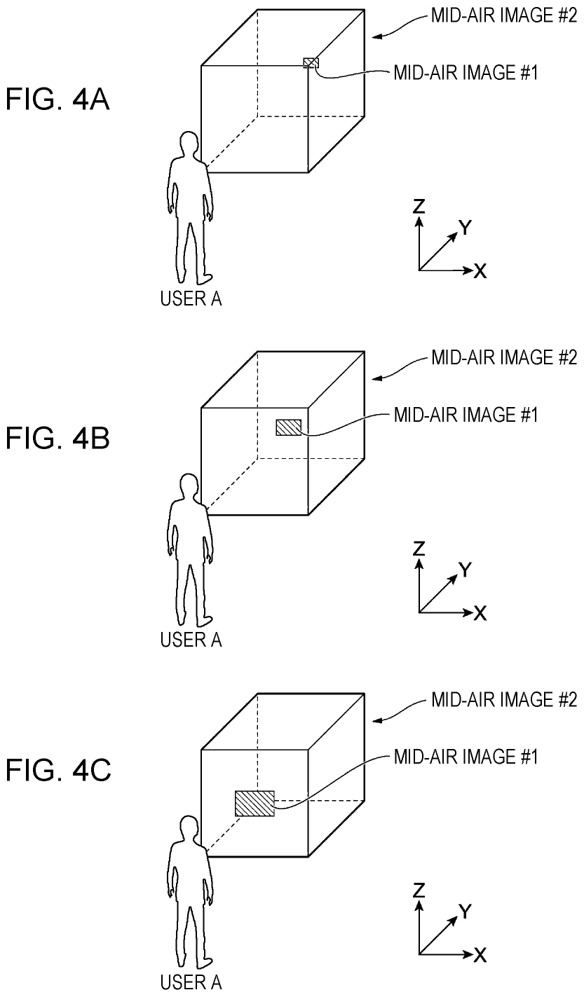

FIGS. 4A to 4C are diagrams illustrating movement of the mid-air image #1 at a time when the user A around the mid-air image #2 receives a message or the like. FIG. 4A illustrates a mid-air image #1 formed at a time Tl, FIG. 4B illustrates a mid-air image #1 formed at a time T2, and FIG. 4C illustrates a mid-air image #1 formed at a time T3.

The movement of the mid-air image #1 illustrated in FIGS. 4A to 4C is used when a sender is located at the far side of the mid-air image #2 from the user A or when reception of a message or the like is represented regardless of a position of the sender.

In FIGS. 4A to 4C, the mid-air image #1 approaches the user A from the far side of the mid-air image #2 to the near side of the mid-air image #2 while increasing the size. The size of the mid-air image #1 is increased in an exaggerated manner regardless of a distance in actual space in which the mid-air image #2 is formed. Even when a distance in a depth direction over which the mid-air image #1 moves is small, therefore, it is easy for the user A to understand that the mid-air image #1 is approaching.

In FIGS. 4A to 4C, a small mid-air image #1 is formed at the time T1 on the far side of the mid-air image #2, a medium mid-air image #1 is formed at the time T2 around the center of the mid-air image #2, and a large mid-air image #1 is formed at the time T3 in the mid-air image #2 just in front of the user A. It is therefore easy for the user A to understand that he/she is receiving a message or the like.

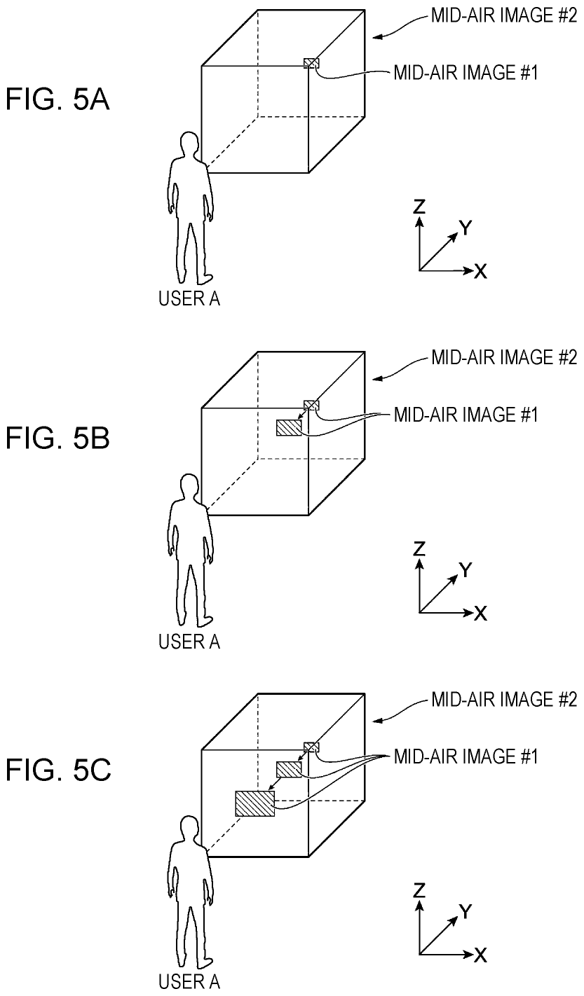

FIGS. 5A to 5C are diagrams illustrating an example in which plural mid-air images #1 having different sizes are used to present the mid-air image #1 approaching the user A. FIG. 5A illustrates a mid-air image #1 formed at the time Tl, FIG. 5B illustrates a mid-air image #1 at the time T2, and FIG. 5C illustrates a mid-air image #1 formed at the time T3. In FIGS. 5A to 5C, the same elements as in FIGS. 4A to 4C are given the same reference numerals.

In FIGS. 5A to 5C, an arrow indicating a position of the mid-air image #1 at each time in the past and a direction of movement is also formed in the air as part of the mid-air image #1. It is therefore easier for the user A to recognize the direction of the movement of the mid-air image #1. This, however, becomes difficult when too many mid-air images #1 are formed in the air. In the example illustrated in FIGS. 5A to 5C, therefore, the number of mid-air images #1 formed in the air is limited to three. That is, the number of points in time at which a mid-air image #1 is formed is limited to three. The three points in time may have the same interval but may be determined in consideration of clear expression of the movement of the mid-air image #1 through the air.

Alternatively, arrows indicating directions of movement need not be formed in the air.

### SECOND EXAMPLE

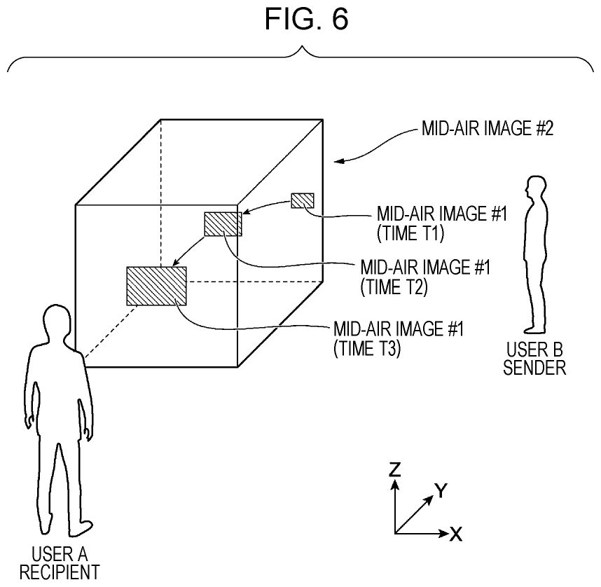

FIG. 6 is a diagram illustrating an example in which the movement of the mid-air image #1 reflects the positional relationship between the sender and the recipient in actual space.

In FIG. 6, the user A is the recipient, and the user B is the sender. The user B is located to the right of the user A. The users A and B need not be in the same room.

In FIG. 6, the mid-air image #1 representing a message or the like approaches the user A from a far-right part of the mid-air image #2 drawing a curve. As illustrated in FIGS. 4A to 4C, the movement of the mid-air image #1 illustrated in FIG. 6 is expressed by a mid-air image #1 at each time whose size increases at a next time.

The user A sees the movement of the mid-air image #1 and understands that he/she is receiving a message or the like and that the sender is located to the right thereof.

A position of the mid-air image #2 at the time T3 in the depth direction may reflect a distance between the users A and B. When the user B is in the same room as the user A, for example, the mid-air image #1 may move in an X-axis direction.

### THIRD EXAMPLE

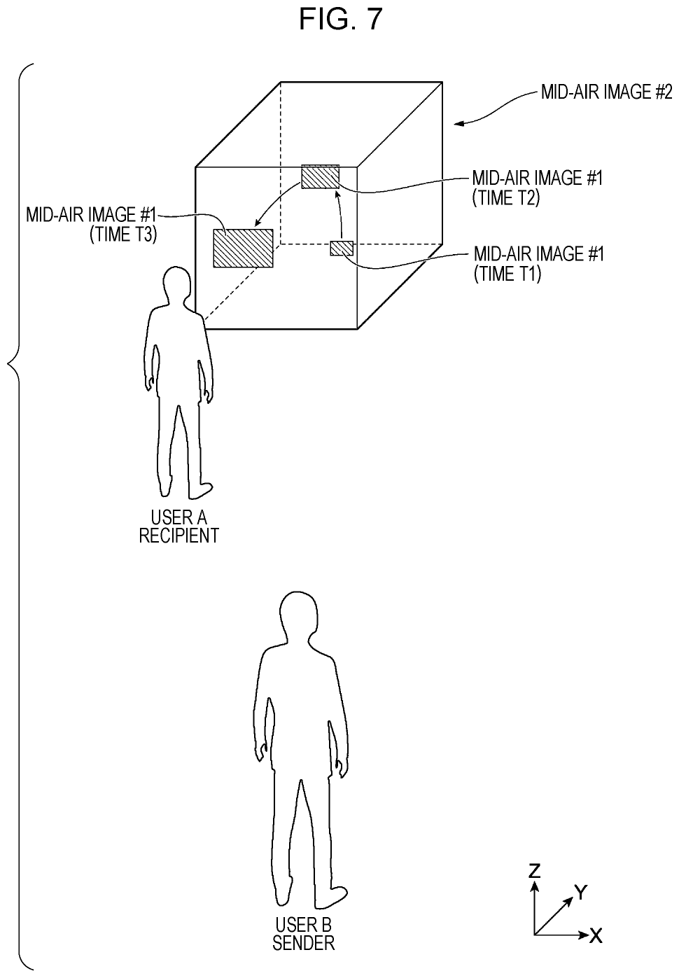

FIG. 7 is a diagram illustrating another example in which the movement of the mid-air image #1 reflects the positional relationship between the sender and the recipient in actual space.

In FIG. 7, too, the user A is the recipient, and the user B is the sender. In FIG. 7, however, the user B is located behind the user A.

In the example illustrated in FIG. 7, therefore, the mid-air image #1 representing a message or the like appears on the near side of the mid-air image #2 from the user A and moves farther into the mid-air image #2 while increasing the size, and then makes a U-turn and approaches the user A.

The user A sees the movement of the mid-air image #1 and understands that he/she is receiving a message or the like and that the sender is located therebehind.

When the user B is located behind the user A, too, the size of the mid-air image #1 at the time T1 may be the same as the size of the mid-air image #1 at the time T3. In this case, the mid-air image #1 becomes smaller as the mid-air image #1 moves farther into the mid-air image #2 and then becomes larger as the mid-air image #1 makes a U-turn and approaches the user A.

### FOURTH EXAMPLE

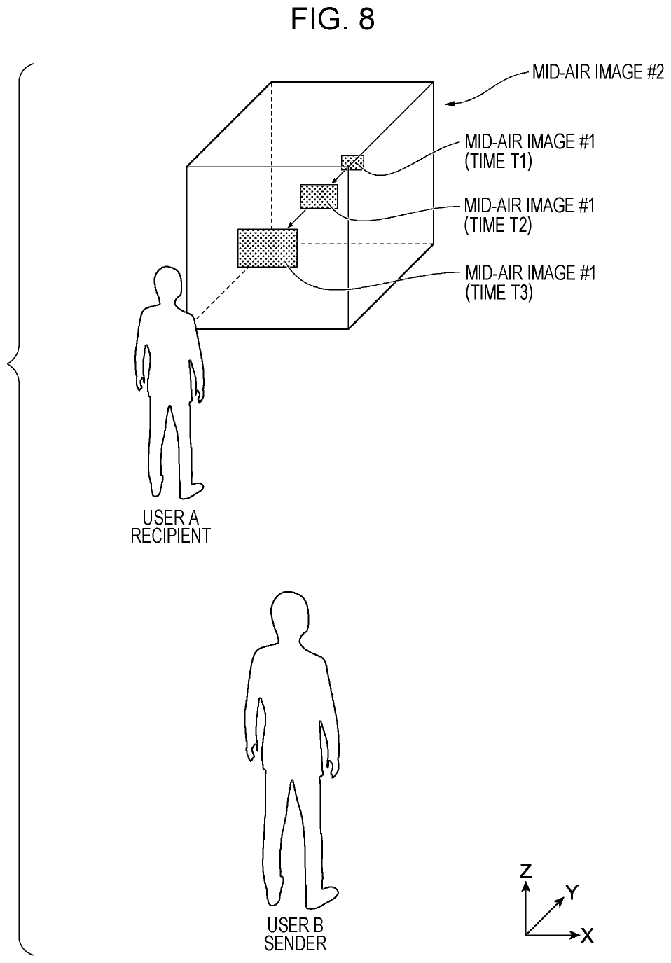

FIG. 8 is a diagram illustrating another example in which the movement of the mid-air image #1 reflects the positional relationship between the sender and the recipient in actual space.

In FIG. 8, too, the user A is the recipient, and the user B is the sender. In FIG. 8, too, the user B is located behind the user A. The positional relationship is the same as in the third example.

The mid-air image #1 illustrated in FIG. 8, however, linearly approaches the user A from the far side of the mid-air image #2. The mid-air image #1 becomes larger as the mid-air image #1 approaches the user A.

A difference is the color of the mid-air image #1. In order to indicate that the user B, who is the sender, is located behind the user A, the mid-air image #1 has a different color in FIG. 8 than in the other examples. Alternatively, a different pattern or design may be used for the mid-air image #1. Anyway, the user A recognizes the difference in color and understands that the sender of the mid-air image #1 moving in front thereof is located therebehind.

### FIFTH EXAMPLE

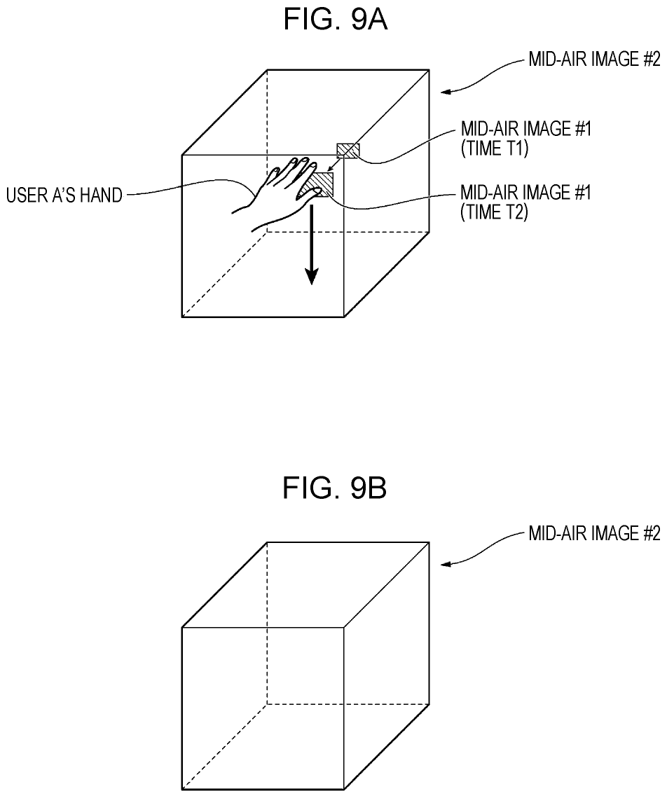

FIGS. 9A and 9B are diagrams illustrating a case where a motion that prevents the movement of the mid-air image #1 is detected. FIG. 9A illustrates a motion of a hand that prevents the movement of the mid-air image #1, and FIG. 9B illustrates a state after the motion of the hand that prevents the movement of the mid-air image #1 is detected.

FIG. 9A corresponds to the time T2 illustrated in FIG. 4B. That is, the mid-air image #1 has moved from the far side of the mid-air image #2 to around the center of the mid-air image #2. At this time, the user A′s hand knocks down the mid-air image #1 while the mid-air image #1 is moving. The user A′s hand naturally passes through the mid-air image #1 since the mid-air image #1 is formed in the air.

The processor 21 (refer to FIG. 1), however, detects a motion that prevents the movement of the mid-air image #1 performed by the user A, who is the recipient, and cancels an event in which a message or the like corresponding to the mid-air image #1 is received. As a result, at the time T3, the mid-air image #1 has been removed from the air. The user A understands from the removal of the mid-air image #1 that his/her motion has been detected.

### SIXTH EXAMPLE

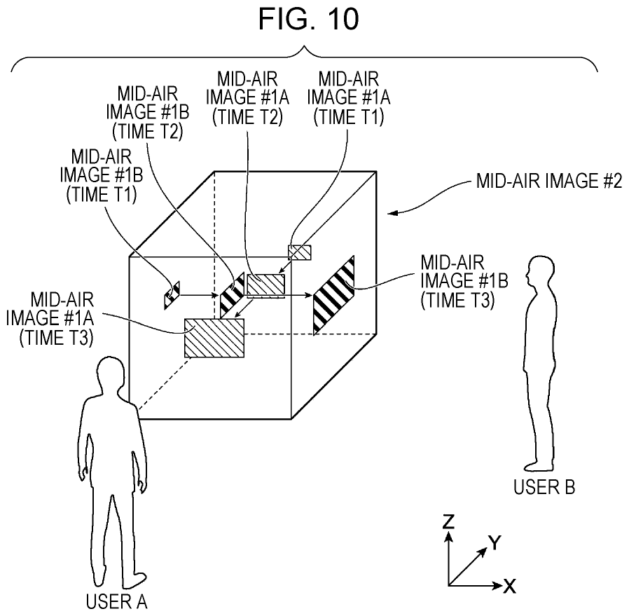

FIG. 10 is a diagram illustrating an example in which two mid-air images #1A and #1B whose recipients are different from each other are formed.

In FIG. 10, the users A and B are the recipients. The users A and B face different sides of the mid-air image #2. In FIG. 10, the user A faces a side defined by X and Z axes, and the user B faces a side defined by Y and Z axes.

In FIG. 10, the mid-air image #1A represents reception of a message or the like to the user A, and the mid-air image #1B represents reception of a message or the like to the user B.

As described in the first example, the movement of the mid-air images #1A and #1B in FIG. 10 is not related to positions of senders. The mid-air images #1A and #1B, therefore, linearly approach the users A and B, respectively, while increasing the size.

### SEVENTH EXAMPLE

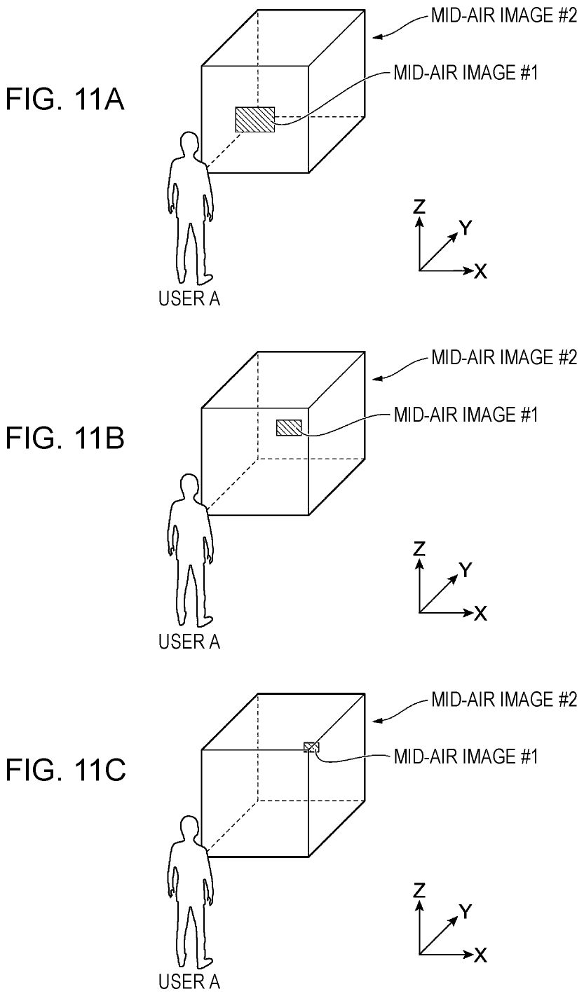

FIGS. 11A to 11C are diagrams illustrating the movement of the mid-air image #1 at a time when the user A around the mid-air image #2 sends a message or the like. FIG. 11A illustrates a mid-air image #1 formed at the time Tl, FIG. 11B illustrates a mid-air image #1 formed at the time T2, and FIG. 11C illustrates a mid-air image #1 formed at the time T3.

The movement of the mid-air image #1 illustrated in FIGS. 11A to 11C is used when the recipient is located at the far side of the mid-air image #2 from the user A, who is the sender, or when sending of a message or the like is represented regardless of a position of the recipient.

In FIGS. 11A to 11C, the mid-air image #1 moves away from the user A from the near side of the mid-air image #2 to the far side of the mid-air image #2 while reducing the size. The size of the mid-air image #1 is reduced in an exaggerated manner regardless of a distance in actual space in which the mid-air image #2 is formed. Even when a distance in the depth direction over which the mid-air image #1 moves is small, therefore, it is easy for the user A to understand that the mid-air image #1 is moving away.

In FIGS. 11A to 11C, a large mid-air image #1 is formed at the time T1 in the mid-air image #2 just in front of the user A, a medium mid-air image #1 is formed at the time T2 around the center of the mid-air image #2, and a small mid-air image #1 is formed at the time T3 on the far side of the mid-air image #2. It is therefore easy for the user A to understand that he/she is sending a message or the like.

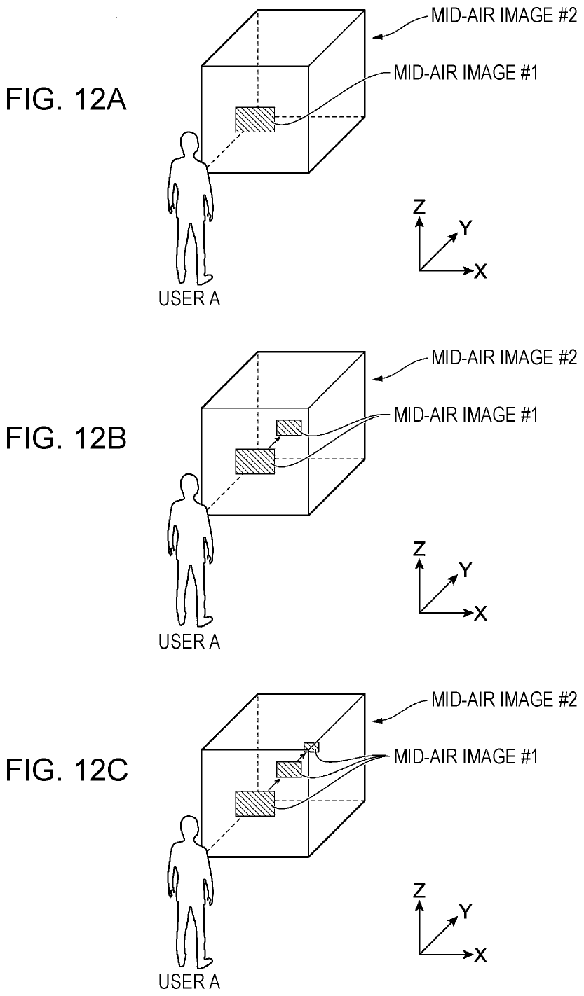

FIGS. 12A to 12C are diagrams illustrating an example in which plural mid-air images #1 having different sizes are used to present the mid-air image #1 moving away from the user A. FIG. 12A illustrates a mid-air image #1 formed at the time Tl, FIG. 12B illustrates a mid-air image #1 at the time T2, and FIG. 12C illustrates a mid-air image #1 formed at the time T3. In FIGS. 12A to 12C, the same elements as in FIGS. 11A to 11C are given the same reference numerals.

In FIGS. 12A to 12C, an arrow indicating a position of the mid-air image #1 at each time in the past and a direction of movement is also formed in the air as part of the mid-air image #1. It is therefore easier for the user A to recognize the direction of the movement of the mid-air image #1. This, however, becomes difficult when too many mid-air images #1 are formed in the air. In the example illustrated in FIGS. 12A to 12C, therefore, the number of mid-air images #1 formed in the air is limited to three. That is, the number of points in time at which a mid-air image #1 is formed is limited to three. The three points in time may have the same interval but may be determined in consideration of clear expression of the movement of the mid-air image #1 through the air.

Alternatively, arrows indicating directions of movement need not be formed in the air.

### EIGHTH EXAMPLE

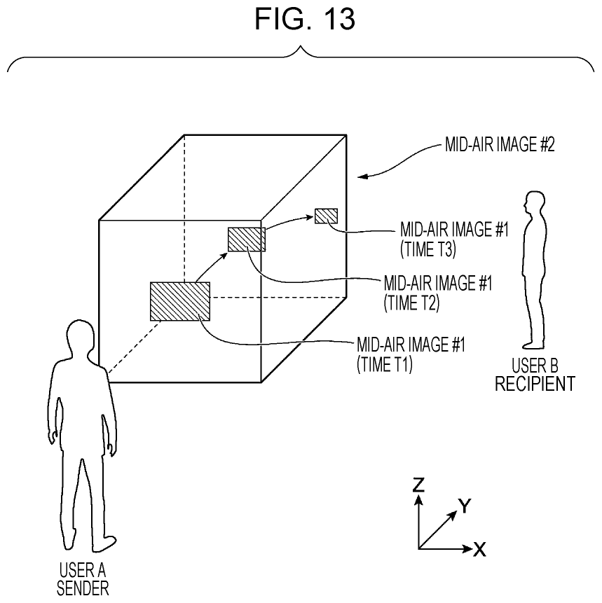

FIG. 13 is a diagram illustrating another example in which the movement of the mid-air image #1 reflects the positional relationship between the sender and the recipient in actual space.

In FIG. 13, the user A is the sender, and the user B is the recipient. The user B is located to the right of the user A. The users A and B need not be in the same room.

In FIG. 13, the mid-air image #1 representing a message or the like approaches the user B from a position just in front of the user A to the far-right part of the mid-air image #2 drawing a curve. As in FIGS. 11A to 11C, the mid-air image #1 illustrated in FIG. 13 moves while reducing the size.

The user A sees the movement of the mid-air image #1 and understands that he/she is sending a message or the like and that the recipient is located to the right thereof.

A position of the mid-air image #2 at the time T3 in the depth direction may reflect a distance between the users A and B. When the user B is in the same room as the user A, for example, the mid-air image #1 may move in the X-axis direction.

### NINTH EXAMPLE

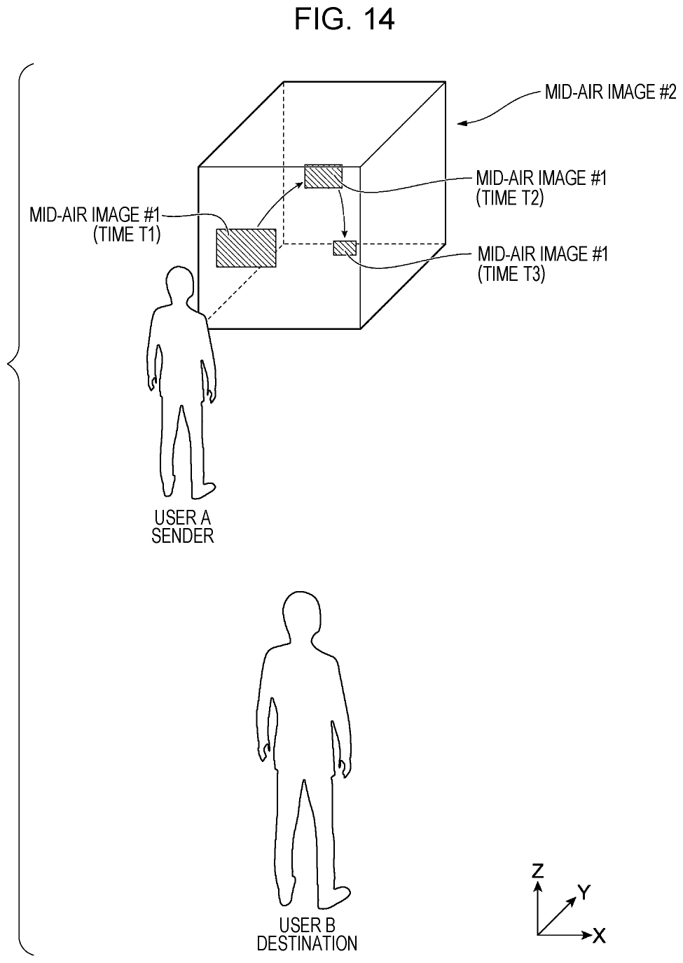

FIG. 14 is a diagram illustrating another example in which the movement of the mid-air image #1 reflects the positional relationship between the sender and the recipient in actual space.

In FIG. 14, too, the user A is the sender, and the user B is the recipient. In FIG. 14, however, the user B is located behind the user A.

In the example illustrated in FIG. 14, therefore, the mid-air image #1 representing a message or the like appears in front of the user A and moves farther into the mid-air image #2 while reducing the size, and then makes a U-turn and approaches the user A.

The user A sees the movement of the mid-air image #1 and understands that he/she is sending a message or the like and that the recipient is located therebehind.

When the user B is located behind the user A, too, the size of the mid-air image #1 at the time T3 may be the same as the size of the mid-air image #1 at the time Tl. In this case, the mid-air image #1 becomes smaller as the mid-air image #1 moves farther into the mid-air image #2, and becomes larger again as the mid-air image #1 makes a U-turn and approaches the user A.

### TENTH EXAMPLE

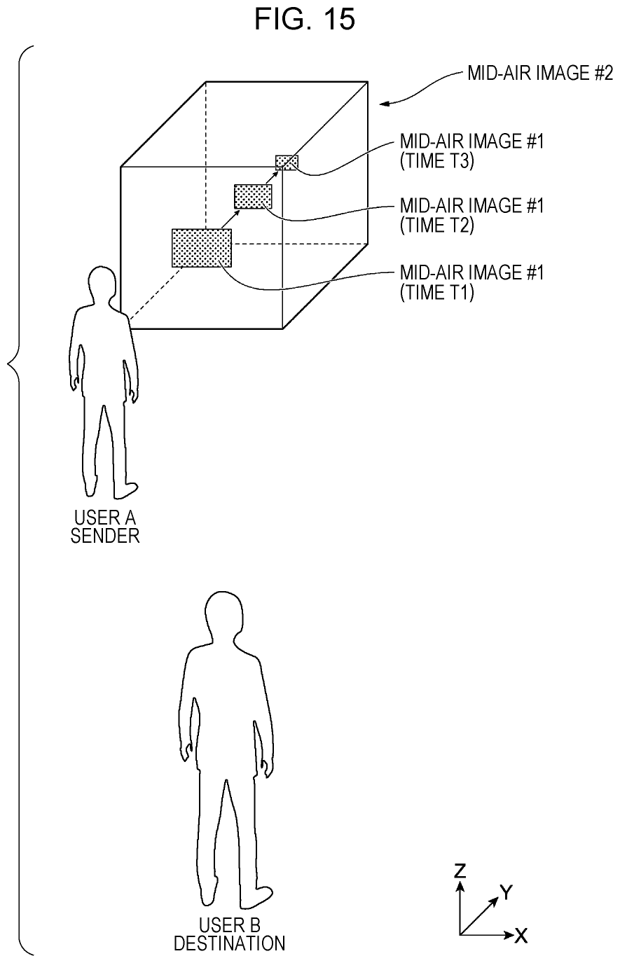

FIG. 15 is a diagram illustrating another example in which the movement of the mid-air image #1 reflects the positional relationship between the sender and the recipient in actual space.

In FIG. 15, too, the user A is the sender, and the user B is the recipient. In FIG. 15, too, the user B is located behind the user A. The positional relationship is the same as in the ninth example.

The mid-air image #1 illustrated in FIG. 15, however, linearly moves farther into the mid-air image #2 from the position just in front of the user A. The mid-air image #1 becomes smaller as the mid-air image #1 moves away from the user A.

A difference is the color of the mid-air image #1. In order to indicate that the user B, who is the recipient, is located behind the user A, the mid-air image #1 has a different color in FIG. 15 than in the other examples. Alternatively, a different pattern or design may be used for the mid-air image #1. Anyway, the user A recognizes the difference in color and understands that the recipient of the mid-air image #1 moving in front thereof is located therebehind.

### ELEVENTH EXAMPLE

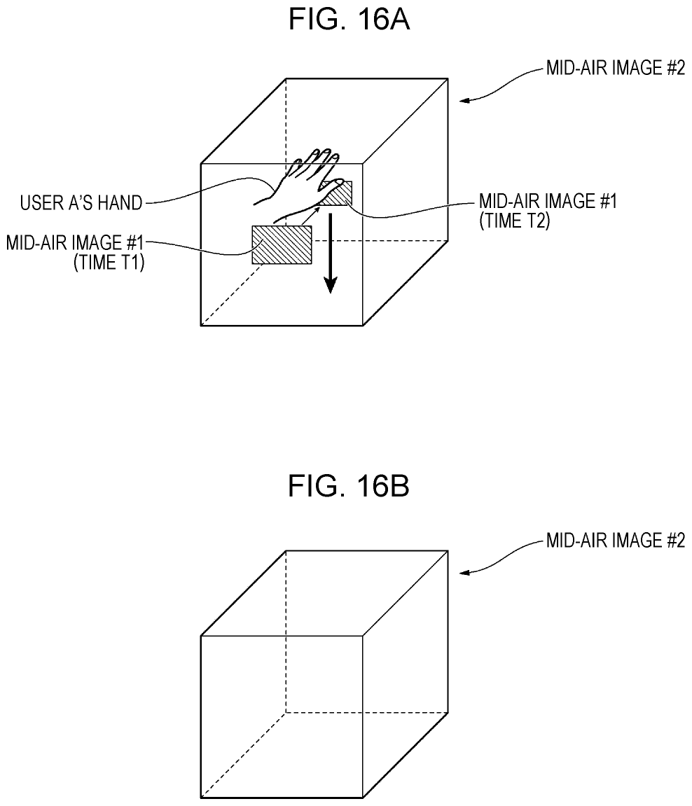

FIGS. 16A and 16B are diagrams illustrating another case where a motion that prevents the movement of the mid-air image #1 is detected. FIG. 16A illustrates a motion of a hand that prevents the mid-air image #1, and FIG. 16B illustrates a state after the motion of the hand that prevents the movement of the mid-air image #1 is detected.

FIG. 16A corresponds to the time T2 illustrated in FIG. 11B. That is, the mid-air image #1 has moved from the near side of the mid-air image #2 to around the center of the mid-air image #2. At this time, the user A's hand knocks down the mid-air image #1 while the mid-air image #1 is moving. The user A′s hand naturally passes through the mid-air image #1 since the mid-air image #1 is formed in the air.

The processor 21 (refer to FIG. 1), however, detects a motion that prevents the movement of the mid-air image #1 performed by the user A, who is the sender, and cancels an event in which a message or the like corresponding to the mid-air image #1 is sent. As a result, at the time T3, the mid-air image #1 has been removed from the air. The user A understands from the removal of the mid-air image #1 that his/her motion has been detected.

### TWELFTH EXAMPLE

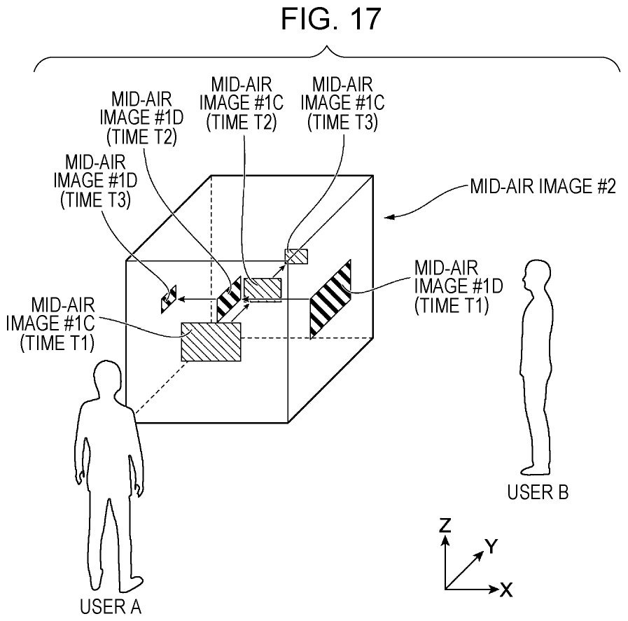

FIG. 17 is a diagram illustrating an example in which two mid-air images #1C and #1D whose senders are different from each other are formed.

In FIG. 17, the users A and B are the senders. The users A and B face different sides of the mid-air image #2. In FIG. 17, the user A faces the side defined by the X and Z axes, and the user B faces the side defined by the Y and Z axes.

In FIG. 17, the mid-air image #1C represents sending of a message or the like from the user A, and the mid-air image #1D represents sending of a message or the like from the user B.

As described in the seventh example, the movement of the mid-air images #1C and #1D in FIG. 17 is not related to positions of recipients. The mid-air images #1C and #1D, therefore, linearly move away from the users A and B, respectively, while reducing the size.

### Modifications

Although an exemplary embodiment of the present disclosure has been described above, the technical scope of the present disclosure is not limited to that of the exemplary embodiment. It is obvious from the claims that the technical scope of the present disclosure also includes modes obtained by modifying or improving the above exemplary embodiment in various ways.

Although the cubic mid-air image #2 is formed in the air in order to make it easier for the user to see movement of the mid-air image #1 through the air in the above exemplary embodiment, the mid-air image #2 need not be formed. That is, only the mid-air image #1 may be formed in the air and moved in accordance with a direction of communication, instead.

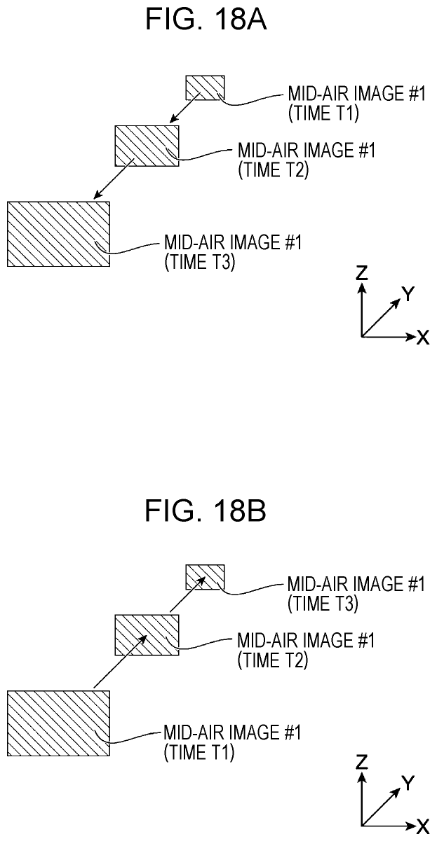

FIGS. 18A and 18B are diagrams illustrating an example in which the mid-air image #2 is not formed as a reference for the mid-air image #1. FIG. 18A illustrates movement of a mid-air image #1 representing reception of a message or the like, and FIG. 18B illustrates movement of a mid-air image #1 representing sending of a message or the like.

The movement of the mid-air image #1 illustrated in FIG. 18A corresponds to the movement of the mid-air image #1 illustrated in FIGS. 4A to 4C, and the movement of the mid-air image #1 illustrated in FIG. 18B corresponds to the movement of the mid-air image #1 illustrated in FIGS. 11A to 11C.

Although a shape of the mid-air image #1 remains the same regardless of the amount of data of a message or the like in the above exemplary embodiment, the shape of the mid-air image #1 may change depending on the amount of data of a message or the like, instead. The amount of data of a message or the like is an example of the amount of communication data.

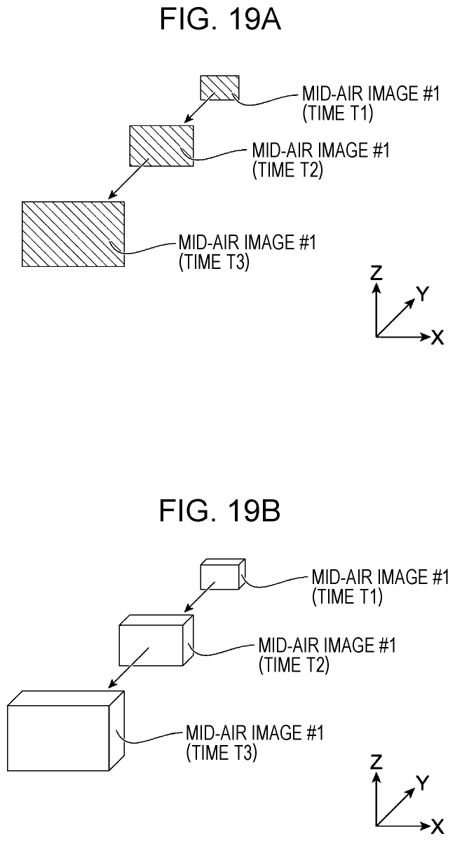

FIGS. 19A and 19B are diagrams illustrating an example in which the shape of the mid-air image #1 indicates the amount of data of a message or the like. FIG. 19A illustrates a shape corresponding to a small amount of data, and FIG. 19B illustrates a shape corresponding to a large amount of data.

In FIGS. 19A and 19B, a difference in the amount of data is represented by a difference in the volume of the mid-air image #1. More specifically, a difference in the amount of data is represented by a difference in the thickness of the mid-air image #1. The thickness of the mid-air image #1 may be continuously varied within a predetermined range in proportion to the amount of data.

Alternatively, the thickness of the mid-air image #1 may be determined by comparing the amount of data with a predetermined threshold. The number of thresholds is not limited to one, and plural thresholds may be used, instead.

The threshold may be determined in accordance with a type of data sent. For example, a threshold for data files, content data, and program data may be larger than one for messages.

Alternatively, the size or color of the mid-air image #1 may be changed instead of the thickness of the mid-air image #1.

In addition, although the mid-air image forming apparatus 10 (refer to FIG. 1) and the control apparatus 20 (refer to FIG. 1) are mutually independent apparatuses in the above exemplary embodiment, the mid-air image forming apparatus 10 and the control apparatus 20 may be integrated together, instead.

In addition, the control apparatus 20 according to the above exemplary embodiment may be a computer, an information terminal such as a smartphone, or a server on the Internet, instead.

In the embodiment above, the term “processor 21” (refer to FIG. 1) refers to hardware in a broad sense. Examples of the processor include general processors (e.g., CPU: Central Processing Unit) and dedicated processors (e.g., GPU: Graphics Processing Unit, ASIC: Application-Specific Integrated Circuit, FPGA: Field Programmable Gate Array, and programmable logic device).

In the embodiment above, the term “processor” is broad enough to encompass one processor or plural processors in collaboration which are located physically apart from each other but may work cooperatively. The order of operations of the processor is not limited to one described in the embodiment above, and may be changed.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a processor configured to present, in perspective, movement of an image formed in air.

2. The information processing apparatus according to claim 1, wherein the image becomes larger as the image approaches a person who is observing the image and smaller as the image moves away from the person.

3. The information processing apparatus according to claim 2, wherein:
the movement of the image represents reception of a target by the person, and
the processor is configured to move the image toward the person while increasing size of the image.

4. The information processing apparatus according to claim 3, wherein a route of the movement of the image represents a relationship between a position at which the person who is observing the image is located and a position at which a sender corresponding to the image is located.

5. The information processing apparatus according to claim 4, wherein:
the reception represented by the movement of the image is reception of a target sent from the sender to the person, and
the image is presented in a first color when the sender is located in front of the person and in a second color when the sender is located behind the person.

6. The information processing apparatus according to claim 1, wherein:
the movement of the image represents reception, and
the processor is configured to cancel the reception corresponding to the movement of the image in response to a motion that prevents the movement of the image being detected while the image is moving.

7. The information processing apparatus according to claim 2, wherein:
the movement of the image represents sending of a target by the person, and
the processor is configured to move the image away from the person while reducing size of the image.

8. The information processing apparatus according to claim 7, wherein a route of the movement of the image represents a relationship between a position at which the person is located and a position at which a recipient corresponding to the image is located.

9. The information processing apparatus according to claim 8, wherein:
the sending represented by the movement of the image is sending of the target from the person to the recipient, and
the image is presented in a first color when the recipient is located in front of the person and in a second color when the recipient is located behind the person.

10. The information processing apparatus according to claim 1, wherein:
the movement of the image represents sending, and
the processor is configured to cancel the sending represented by the movement of the image in response to a motion that prevents the movement of the image being detected while the image is moving.

11. The information processing apparatus according to claim 1, wherein volume of the image varies depending on an amount of communication data corresponding to the image.

12. The information processing apparatus according to claim 1, wherein the processor is configured to:
present, in a case where a plurality of persons are present around a space in which the image is formed, the movement of the image to each of the plurality of persons in perspective for the person.

13. The information processing apparatus according to claim 1, wherein the movement of the image takes place inside another image formed in the air.

14. The information processing apparatus according to claim 13, wherein part of the image formed inside the other image is presented in perspective.

15. The information processing apparatus according to claim 1, wherein the processor is configured to switch, in response to a user instruction, presentation mode of the image presented in the air between a perspective mode and a non-perspective mode.

16. The information processing apparatus according to claim 15, wherein the processor is configured to present, in response to the user switching the method from the perspective mode to the non-perspective mode while the movement of the image is in progress, a remaining portion of the movement of the image in the non-perspective mode.

17. A non-transitory computer readable medium storing a program causing a computer to execute a process comprising:
expressing, in perspective, movement of an image formed in air.

18. An information processing apparatus comprising:
processing means for expressing, in perspective, movement of an image formed in air.
